(19) United States
(12) Patent Application Publication
(10) Pub. No.: US 2003/0086370 A1
(43) Pub. Date: May 8, 2003

(54) Voice data transmitting method and terminal for the method

(75) Inventor: Jong Wook Woo, Seoul (KR)

Correspondence Address: FLESHNER & KIM, LLP, 14500 AVION PARKWAY, SUITE 125, CHANTILLY, VA, 20151, US

(73) Assignee: LG Electronics Inc.

(21) Appl. No.: 10/285,532

(22) Filed: Nov. 1, 2002

(30) Foreign Application Priority Data
Nov. 2, 2001 (KR) 2001-68216

(51) Int. Cl. G01R 31/08; G06F 11/00; G08C 15/00; H04J 1/16; H04J 3/14; H04L 1/00; H04L 12/26

(52) U.S. Cl. 370/230

(57) ABSTRACT

A terminal for voice data transmission includes a call processing section for requesting acceptance of use of a transmission bandwidth for a new voice data transmission if a new call is generated, a bandwidth measuring section for measuring a whole transmission bandwidth of data being transmitted in a network and the transmission bandwidth of the new voice data with respect to the request for acceptance, a bandwidth adjustment section for deciding whether to accept the use of the transmission bandwidth based on the measured transmission bandwidths and the transmission bandwidth of a predetermined transmission path, and a bandwidth determining section for determining the transmission bandwidth of the transmission path.

### BACKGROUND OF THE INVENTION

1. Field of the Invention

The present invention generally relates to a mobile communication terminal, and more particularly to a system and method for transmitting voice data as well as a terminal for doing the same.

2. Background of the Related Art

Generally, transmission of voice data is processed on a network, and the processed data is transmitted in a limited manner according to a bandwidth of a transmission path on the network.

FIG. 1 is a diagram illustrating the construction of a proposed network for voice data transmission. The proposed network includes a voice transmission device 20 for processing and transmitting voice data to the network, a transmission network 30 which includes a transmission path for transmitting the voice data, and a voice-band management device 10 for adjusting a bandwidth of the voice data.

The transmission network 30 includes the transmission path which has a limited bandwidth, and serves to transmit the voice data between voice transmission devices.

The voice transmission device 20 converts a user's voice into voice data, and transmits the voice data to the transmission network 30. The transmission network transmits the voice data to a second voice transmission device connected to an opposite (or called) party. Also, the transmission network receives the voice data from the transmission network 30, converts the received voice data into a voice, and outputs the converted voice to a user to enable the voice call.

The voice-band management device manages a voice data transmission bandwidth through the transmission network 30, and serves to prevent the voice data transmission from exceeding the bandwidth of the transmission path of the network by limiting the transmission bandwidth of the voice data transmitted from the voice transmission device 20.

Accordingly, the voice transmission device requests an acceptance of the voice data transmission to the voice-band management device before performing voice data communication through the transmission network. The voice-band management device receives this request and checks whether the voice data of which the transmission acceptance was requested exceeds the transmission bandwidth of the transmission network, by calculating the bandwidth of the voice data that is being transmitted on the transmission network.

If the voice data does not exceed the transmission bandwidth of the transmission network as a result of checking, the voice-band management device accepts the voice data transmission of the corresponding voice transmission device. However if the voice data exceeds the transmission bandwidth of the transmission network as a result of checking, the voice-band management device rejects the voice data transmission of the corresponding voice transmission device. If the voice transmission device receives an acceptance from the voice-band management device 10, it starts the voice data transmission. If the voice transmission device is rejected, it cannot perform the voice data communication.

Through the process described above, voice data transmission is performed in a range that does not exceed the transmission bandwidth of the transmission network 30 to secure voice quality. However, since the voice transmission device cannot perform voice data transmission until it receives an acceptance from the voice-band management device, a waiting time for the acceptance response is produced. During this waiting time, the voice communication cannot be performed. Since this waiting time is produced when the user attempts the voice call using the voice transmission device 20, it takes a long time for the user's initial connection to the opposite (or called) party.

Also, if a plurality of users attempt voice calls by sharing a transmission path having a limited transmission bandwidth and the voice calls are connected without the limitation of the bandwidth according to the limited transmission bandwidth, a call bandwidth that exceeds the bandwidth of the transmission path may be produced and this causes the normal voice calls not to be performed.

### SUMMARY OF THE INVENTION

An object of the invention is to solve at least the above problems and/or disadvantages and to provide at least the advantages described hereinafter.

The present invention is directed to a voice data transmitting method, and a terminal for implementing the method, that substantially obviates one or more problems due to limitations and disadvantages of the related art.

An object of the present invention is to provide a voice data transmitting method and a terminal for the method that reduces an initial voice connection time.

Another object of the present invention is to provide a voice data transmitting method and a terminal for the method that secures a voice bandwidth for a user's normal call.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a voice data processing module includes a call processing section for requesting an acceptance of use of a transmission bandwidth for a new voice data transmission, and processing a corresponding data call according to a result of the request, and a call band limiting section for responding to the request in consideration of the transmission bandwidth presently occupied and the transmission bandwidth of the voice data to be transmitted.

Preferably, the call band limiting section includes a bandwidth determining section for determining the whole transmission bandwidth of the voice data outputted from the voice data processing module, a bandwidth measuring section for measuring the transmission bandwidth presently occupied and the transmission bandwidth of the new voice data, and a bandwidth adjustment section for deciding whether to accept the request in consideration of the measured transmission bandwidths and the determined whole transmission bandwidth.

Preferably, the bandwidth adjustment section rejects the request if a sum of the transmission bandwidth of the new voice data and the transmission bandwidth presently occupied exceeds the whole transmission bandwidth.

Preferably, the whole transmission bandwidth and the transmission bandwidth presently occupied indicate the bandwidth of a transmission path for transmitting therethrough the data outputted from the voice transmission module.

In another aspect of the present invention, a terminal for voice data transmission includes a call processing section for requesting an acceptance of use of a transmission bandwidth for a new voice data transmission, and processing a corresponding data call according to a result of the request, a call bandwidth limiting section for responding to the request in consideration of the transmission bandwidth presently occupied and the transmission bandwidth of the voice data to be transmitted, and a transmission section for processing and transmitting the new voice data according to an acceptance of the request.

In still another aspect of the present invention, a voice data processing method in a voice data processing module including a call band limiting section for judging a call process for itself, includes the steps of requesting an acceptance of use of a transmission bandwidth for a new voice data transmission, responding to the request in consideration of the transmission bandwidth presently occupied and the transmission bandwidth of the voice data to be transmitted, and deciding the call process for the new voice data transmission according to the response.

Preferably, the voice data processing method further includes the steps of determining the whole transmission bandwidth of the voice data outputted from the voice data processing module, measuring the transmission bandwidth presently occupied and the transmission bandwidth of the new voice data, and deciding whether to accept the request in consideration of the measured transmission bandwidths and the determined whole transmission bandwidth.

Preferably, at the deciding step, if a sum of the transmission bandwidth of the new voice data and the transmission bandwidth presently occupied exceeds the whole transmission bandwidth, the request is rejected.

It is to be understood that both the foregoing general description and the following detailed description of the present invention are exemplary and explanatory and are intended to provide further explanation of the invention as claimed.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a view illustrating the construction of a network which has been proposed for voice data transmissions.

FIG. 2 is a view illustrating the construction of a terminal for voice data transmission according to the present invention.

FIG. 3 is a view illustrating a voice data transmitting procedure according to the construction of FIG. 2.

### DETAILED DESCRIPTION OF PREFERRED EMBODIMENTS

Reference will now be made in detail to the preferred embodiments of the present invention, examples of which are illustrated in the accompanying drawings. Wherever possible, the same reference numbers will be used throughout the drawings to refer to the same or like parts.

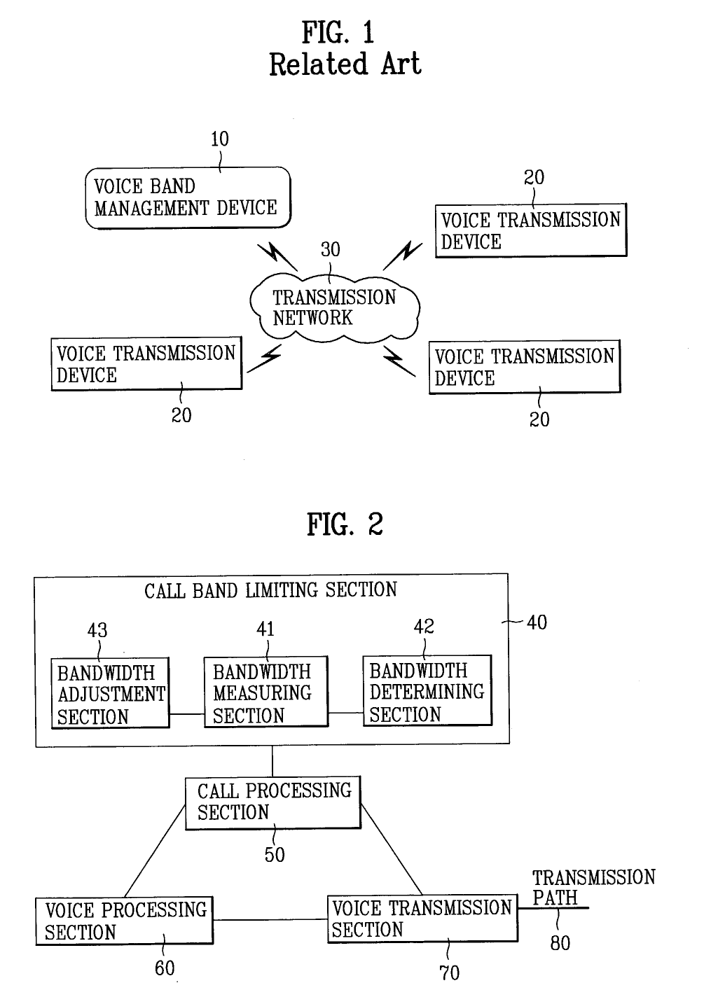

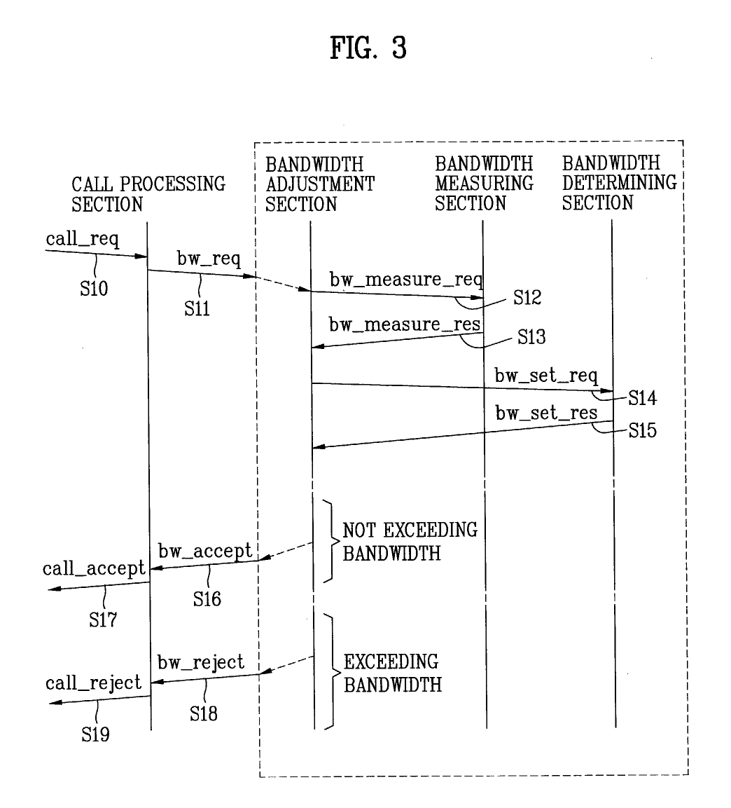

FIG. 2 is a diagram illustrating a construction of a terminal for performing voice data transmissions according to one embodiment of the present invention. FIG. 3 is a diagram illustrating steps included in a method for performing voice data transmissions according to the construction of FIG. 2.

Referring to FIG. 2, a terminal for performing voice data transmissions includes a call band limiting section 40, a call processing section 50, a voice processing section 60, and a voice transmission section 70. The call processing section requests acceptance of use of a transmission bandwidth for a new voice data transmission, and processes a corresponding data call according to a result of the request. The call band limiting section responds to the request in consideration of the transmission bandwidth presently occupied and the transmission bandwidth of the voice data to be transmitted. The voice transmission section processes and transmits the new voice data according to an acceptance of the request. Also included is a transmission path 80 for transmitting an output of the voice transmission section 70 to a voice transmission network.

The call band limiting section includes a bandwidth determining section 43 for determining a transmission bandwidth of the transmission path 80, and having transmission bandwidth information of the transmission path 80 used for the voice data transmission. A bandwidth measuring section 42 records the transmission bandwidth of whole voice data of a voice call presently maintained, and measures the transmission bandwidth of the new voice data if a request for transmission the new voice data is produced. A bandwidth adjustment section 41 receives a request for use of the voice bandwidth due to a new call from the call processing section 50, and judges whether to accept use of the new voice bandwidth using the information of the bandwidth determining section 43 and the bandwidth measuring section 42.

Referring to FIG. 3, if a user requests a voice call (step S10: call_req), the call processing section 50 transmits to the call band limiting section 40 a request for a voice bandwidth (bw_req) in compliance with the generation of a new call (step S11).

The bandwidth adjustment section 41 of the call band limiting section 40 then requests from the bandwidth measuring section 42 the transmission bandwidth of the whole voice data and transmission bandwidth information (bw_measure_req) of the voice data of which the transmission is newly requested (step S12).

Based on the request for bandwidth information, the bandwidth measuring section 42 measures the transmission bandwidth of the whole voice data (i.e., the voice bandwidth presently occupied) and the transmission bandwidth of the voice data of which the transmission is newly requested, and transmits a result of the measurement (bw_measure_res) to the bandwidth adjustment section 41 (step S13).

The bandwidth adjustment section 41 of the call band limiting section 40 requests information on the transmission bandwidth of the transmission path 80 (bw_set_req) to the bandwidth determining section 43, along with a request for the transmission bandwidth information of the voice data (step S14). In accordance with the request for the transmission bandwidth information, the corresponding bandwidth determining section 41 transmits this information to the bandwidth adjustment section 41 (step S15).

The bandwidth adjustment section 41 judges whether the transmission bandwidth of the voice data of which the transmission is newly requested exceeds the transmission bandwidth of the transmission path 80. This judgment is made based on the whole transmission bandwidth of the voice data presently occupied and the transmission bandwidth of transmission path 80.

If it does not exceed the transmission bandwidth of transmission path 80 as determined by a result of the judgment, the bandwidth adjustment section 41 transmits the information indicating an acceptance of the voice bandwidth (bw_accept) to the call processing section 50 (step S16), and the call processing section 50 proceeds to process the new call (call_accept) (step S17). That is, in accordance with the user request, the bandwidth adjustment section connects the call to the destination party.

If the transmission bandwidth for the newly requested transmission of voice data exceeds the transmission bandwidth of the transmission path 80, the bandwidth adjustment section 41 transmits information indicating a rejection of the voice bandwidth (bw_reject) to the call processing section 50 (step S18), and the call processing section 50 rejects the new call (call_reject) (Step S19).

As described above, the transmission device, i.e., the terminal, according to the present invention has a function of maintaining for itself a proper call quality by considering in advance the call bandwidth according to the call request of the terminal in consideration of the transmission bandwidth of the transmission path and the whole transmission bandwidth of the transmitted data presently proceeding.

Also, the transmission device (e.g., the terminal) according to the present invention has an effect of reducing the waiting time for receiving an acceptance response for voice data transmission, by considering in advance the call bandwidth for the voice data transmission in consideration of the transmission bandwidth of the transmission path and the whole transmission bandwidth of the transmitted data presently proceeding.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

What is claimed is:

1. A voice data processing module, comprising:
a call processing section which requests acceptance of use of a transmission bandwidth for transmission of a new voice data, and which processes a corresponding data call based on a result of the request; and
a call band limiting section which responds to the request based on a transmission bandwidth presently occupied and a transmission bandwidth of the new voice data.

2. The voice data processing module of claim 1, wherein the call band limiting section comprises:
a bandwidth determining section which determines a whole transmission bandwidth of voice data output from the voice data processing module;
a bandwidth measuring section which measures the transmission bandwidth presently occupied and the transmission bandwidth of the new voice data; and
a bandwidth adjustment section which decides whether to accept the request based on the measured transmission bandwidth presently occupied, the measured transmission bandwidth of the new voice data and the determined whole transmission bandwidth.

3. The voice data processing module of claim 2, wherein the bandwidth adjustment section rejects the request if a sum of the transmission bandwidth of the new voice data and the transmission bandwidth presently occupied exceeds the whole transmission bandwidth.

4. The voice data processing module of claim 1, wherein the whole transmission bandwidth and the transmission bandwidth presently occupied provide an indication of the bandwidth of a transmission path for transmitting voice data output from the voice transmission module.

5. A terminal for voice data transmission, comprising:
a call processing section which requests acceptance of use of a transmission bandwidth for a new voice data transmission, and which processes a corresponding data call based on a result of the request;
a call bandwidth limiting section which responds to the request based on a transmission bandwidth presently occupied and a transmission bandwidth of the new voice data; and
a transmission section which processes and transmits the new voice data based on an acceptance of the request.

6. The terminal of claim 5, wherein the call band limiting section comprises:
a bandwidth determining section which determines a whole transmission bandwidth of a voice data output from the transmission section;
a bandwidth measuring section which measures the transmission bandwidth presently occupied and the transmission bandwidth of the new voice data; and
a bandwidth adjustment section which decides whether to accept the request based on the measured transmission bandwidth presently occupied, the measured transmission bandwidth of the new voice data, and the determined whole transmission bandwidth.

7. A voice data processing method, comprising:
requesting acceptance of use of a transmission bandwidth for a new voice data transmission;
responding to the request based on transmission bandwidth presently occupied and a transmission bandwidth of the new voice data; and
deciding a call process for the new voice data transmission based on a response in the responding step.

8. The voice data processing method of claim 7, further comprising:
determining a whole transmission bandwidth of a voice data output from a voice data processing module;
measuring the transmission bandwidth presently occupied and the transmission bandwidth of the new voice data; and
deciding whether to accept the request based on the measured transmission bandwidth presently occupied, the measured transmission bandwidth of the new voice data, and the determined whole transmission bandwidth.

9. The voice data processing method of claim 8, wherein the deciding step includes rejecting the request if a sum of the transmission bandwidth of the new voice data and the transmission bandwidth presently occupied exceeds the whole transmission bandwidth.

10. The voice data processing method of claim 7, wherein the whole transmission bandwidth and the transmission bandwidth presently occupied indicate a bandwidth of a transmission path for transmitting data output from the voice transmission module.

11. A voice data transmitting method, comprising:
requesting acceptance of use of a transmission bandwidth for a new voice data transmission;
responding to the request based on the transmission bandwidth presently occupied and the transmission bandwidth of the voice data to be transmitted;
determining a call for the new voice data transmission based on a response from the responding step; and
processing and transmitting the new voice data in a state that the call is determined.

12. The voice data transmitting method of claim 11, wherein the determining step includes rejecting the request if a sum of the transmission bandwidth of the new voice data and the transmission bandwidth presently occupied exceeds the whole transmission bandwidth.
